(19) United States
(12) Patent Application Publication
(10) Pub. No.: US 2012/0212593 A1
(43) Pub. Date: Aug. 23, 2012

(54) USER WEARABLE VISUAL ASSISTANCE SYSTEM

(75) Inventors: Erez Na'aman, Tel Aviv (IL); Amnon Shashua, Jerusalem (IL); Yonatan Wexler, Jerusalem (IL)

(73) Assignee: ORCAM TECHNOLOGIES LTD., Jerusalem (IL)

(21) Appl. No.: 13/397,919

(22) Filed: Feb. 16, 2012

Related U.S. Application Data
(60) Provisional application No. 61/443,776, filed on Feb. 17, 2011.
(60) Provisional application No. 61/443,739, filed on Feb. 17, 2011.

(51) Int. Cl. H04N 7/18

(52) U.S. Cl. 348/62; 348/E07.085

(57) ABSTRACT

A visual assistance device wearable by a person. The device includes a camera and a processor. The processor captures multiple image frames from the camera. A candidate image of an object is searched in the image frames. The candidate image may be classified as an image of a particular object or in a particular class of objects and is thereby recognized. The person is notified of an attribute related to the object.

### CROSS REFERENCE TO RELATED APPLICATIONS

The present application claims priority to U.S. provisional patent application Ser. No. 61/443,776 filed on 17 Feb. 2011 and U.S. provisional patent application Ser. No. 61/443,739 filed on 17 Feb. 2011.

### BACKGROUND

1. Technical Field

Aspects of the present invention relate to a user wearable visual assistance system.

2. Description of Related Art

The visually impaired suffer from difficulties due to lack of visual acuity, field of view, color perception and other forms of visual impairments. These challenges impact life in many aspects for example mobility, risk of injury, independence and situational awareness in everyday life.

Many products offer solutions in the realm of mobility such as global positioning system (GPS), obstacle detection without performing recognition, and screen readers. These products may lack certain crucial aspects to integrate fully and seamlessly into the life of a visually impaired person.

Thus, there is a need for and it would be advantageous to have a device which integrates new concepts of a supporting and enhancing quality of life for the visually impaired.

### BRIEF SUMMARY

According to features of the present invention, various methods and devices are provided for visually assisting a person using a device wearable by the person. The device includes a camera and a processor. The processor captures multiple image frames from the camera.

A candidate image of an object is searched in the image frames. The candidate image may be classified as an image of a particular object or in a particular class of objects and is thereby recognized. The person is notified of an attribute related to the object. The candidate image may be of a specific hand gesture, and the classification includes recognizing the specific hand gesture. The device may audibly confirm to the person that the specific hand gesture is recognized. The candidate image may be of an object in the environment of the person other than a hand gesture and the device may be controlled responsive to the object in the environment. The person may track the candidate image to provide a tracked candidate image in the image frames. The tracking may be based on sound perception, partial vision or situational awareness by orienting the head-worn camera in the direction of the object. The tracked candidate image may be then selected for classification and recognition. Responsive to the recognition of the object, the person may be audibly notified of an attribute related to the object. The device may be configured to recognize a bus, a traffic signal and/or a bank note. Alternatively, the device may be configured to recognize a bus and a traffic signal. Alternatively, the device may be configured to recognize a bus and a bank note. Alternatively, the device may be configured to recognize a traffic signal and a bank note. If the recognized object is a bus, the attribute provided may be the number of the bus line, the destination of the bus, or the route of the bus. If the recognized object is a traffic signal then the attribute may be the state of the traffic signal. If the recognized object is a bank note then the attribute may be the denomination of the bank note.

Various methods are described herein for operating a device wearable by a person. The device includes a camera and a processor. The processor captures multiple image frames from the camera. A gesture of the person is detected in the field of view of the camera. The gesture may be classified as one of multiple gestures to produce a recognized gesture. Responsive to the recognized gesture, an audible output is provided and may be heard by the person. The device may be controlled based on the recognized gesture. The visual field of the camera may be swept to search for a hand or a face. In order to perform the classification, a multi-class classifier may be trained with multiple training images of multiple classes of objects to provide a trained multi-class classifier. The classification may then be performed using the trained multi-class classifier by storing the trained multi-class classifier and loading the processor with the trained multi-class classifier. The objects in the multiple classes may include traffic lights, bank notes, gestures and/or buses. When the gesture points for instance using a finger in the vicinity of text in a document, the image frames may be analyzed to find the text in the document. The analysis may be performed by increasing the resolution of the camera responsive to the detection of the gesture. Recognition of the text may be performed to produce recognized text. The audible output may include reading the recognized text to the person.

According to features of the present invention, various devices wearable by a person may be provided which include a camera and a processor. The processor captures multiple image frames from the camera. The device is operable to detect a gesture of the person in the field of view of the camera. The device may classify the gesture as one of multiple gestures to produce thereby a recognized gesture. The device may respond to the recognized gesture to provide an audible output to the person. The device may control the device based on the recognized gesture. The device may sweep the visual field of the camera and thereby search for an object which may be a hand or a face.

A multi-class classifier may be trained with multiple training images of multiple classes of objects prior to the classification to produce a trained multi-class classifier. The device may store the trained multi-class classifier and load the processor with the trained multi-class classifier. The classification may then performed using the trained multi-class classifier. The objects may include traffic lights, bank notes, gestures or buses. When the gesture points in the vicinity of text in a document, the device may analyze the image frames to find the text in the document and perform recognition of the text to produce recognized text. The analysis may increase resolution of the camera responsive to detection of the gesture. The audible output may include reading the recognized text to the person.

According to features of the present invention, there is provided an apparatus to retrofit eyeglasses. The apparatus may include a docking component attachable to an arm of the eyeglasses and a camera attachable, detachable and re-attachable to the docking component. The camera may magnetically attach, detach and re-attach to the docking component. The apparatus may further include a processor operatively attached to the camera and an audio unit, operatively attached to the processor, adapted to be in proximity to an ear of the user. The processor may be configured to provide an output to the audio unit responsive to recognition of an object in the field of view of the camera.

The processor may be a portion of a smart phone. The audio unit may include a bone conduction headphone to provide the audible output to the user. The camera may be substantially located at or near the frame front of the eye glasses. The camera may be adapted to capture image frames in a view substantially the same as the view of the person.

### BRIEF DESCRIPTION OF THE DRAWINGS

The invention is herein described, by way of example only, with reference to the accompanying drawings, wherein:

FIG. 1 shows a system diagram, according to aspects of the present invention.

FIG. 2a shows an isometric view of an apparatus, according a feature of the present invention.

FIG. 2b shows an alternative isometric view of the apparatus shown in FIG. 2a, showing came, according to a feature of the present invention.

FIG. 3 shows eyeglasses retrofit according to a feature of the present invention.

FIG. 4 shows retrofit of eyeglasses shown in FIG. 3 with a portion of the apparatus shown in FIGS. 2a and 2b, according to a feature of the present invention.

FIG. 5a-5c, FIG. 6 and FIGS. 7-8 are flow diagrams which illustrate processes according to different features of the present invention.

FIG. 9a shows a person wearing eyeglasses as shown in FIG. 4 and gesturing.

FIGS. 9b-9e show other possible hand gestures in the visual field of the camera, according to different aspects of the present invention.

FIGS. 10-13 shows further examples of a person wearing and using the device of FIG. 4 for detecting and recognizing text, a bus, a bank note and a traffic signal.

### DETAILED DESCRIPTION

Reference will now be made in detail to features of the present invention, examples of which are illustrated in the accompanying drawings, wherein like reference numerals refer to the like elements throughout. The features are described below to explain the present invention by referring to the figures.

Before explaining features of the invention in detail, it is to be understood that the invention is not limited in its application to the details of design and the arrangement of the components set forth in the following description or illustrated in the drawings. The invention is capable of other features or of being practiced or carried out in various ways. Also, it is to be understood that the phraseology and terminology employed herein is for the purpose of description and should not be regarded as limiting.

By way of introduction, embodiments of the present invention utilize a user-machine interface in which the existence of an object in the environment of a user and a hand gesture trigger the device to notify the user regarding an attribute of the object.

The term “frame front” as used herein refers to the front part of the eyeglass frame that holds the lenses in place and bridges the top of the nose.

The term “bone conduction” as used herein refers to the conduction of sound to the inner ear through the bones of the skull.

The term “classify” is used herein in the context of vision processing of candidate image and refers to recognizing an object to belong to a specific class of objects. Examples of classes of objects include buses, hand gestures, bank notes and traffic signals.

The term “attribute” is used herein refers to specific information of the recognized object. Examples may include the state of a recognized traffic signal, or a recognized hand gesture which may be used for a control feature of the device; the denomination of a recognized bank note is an attribute of the bank note; the bus number is an attribute of the recognized bus.

The term “tracking” an image as used herein refers to maintaining the image of a particular object in the image frames. Tracking may be performed by a head-worn camera by the user of the device by orienting or maintaining his head in the general direction of the object. Tracking may be performed by the visually impaired user by sound, situational awareness, or by partial vision. Tracking is facilitated when there is minimal parallax error between the view of the person and the view of the camera.

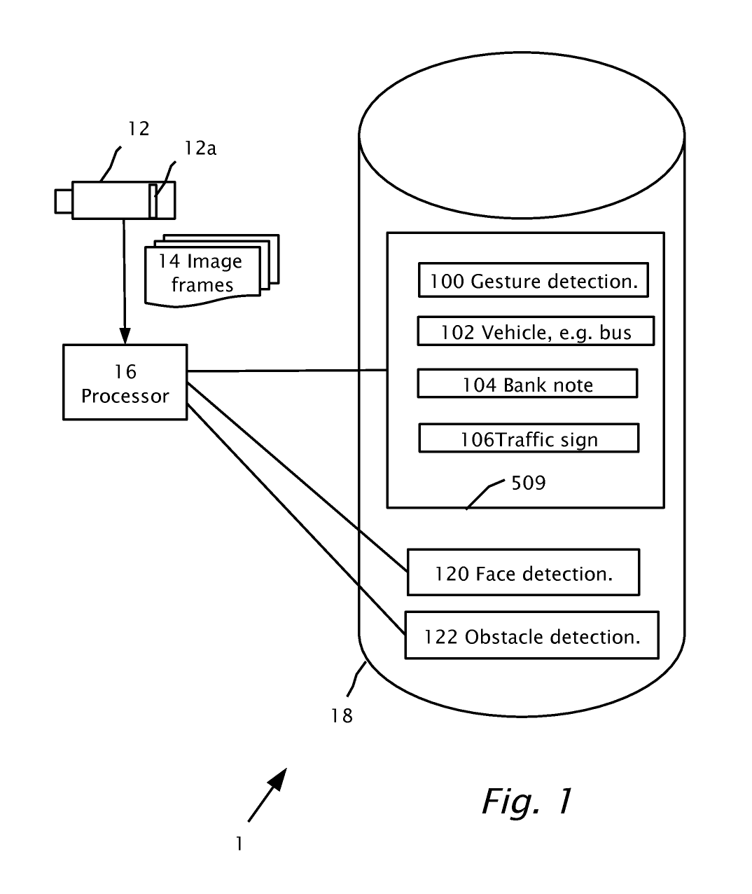

Reference is now made to FIG. 1 which shows a system 1, according to a feature of the present invention. A camera 12 with image sensor 12a which captures image frames 14 in a forward view of camera 12. Camera 12 may be a monochrome camera, a red green blue (RGB) camera or a near infra red (NIR) camera. Image frames 14 are captured and transferred to processor 16 to be processed. The processing of image frames 14 may be based upon algorithms in memory or storage 18. Storage 18 is shown to include a classifier 509 which may include gesture detection 100, vehicle detection and recognition 102, bank note detection and recognition 104 and/or traffic sign detection and recognition 106. Classifier 509 may be a multi-class classifier and may include, for example, multiple classes of different images of different objects including bank notes, vehicles, e.g. buses, traffic signs and/or signals, and gestures. Another classifier may be available for face detection 120. An algorithm may be available for obstacle detection 122 with or without use of an additional sensor (not shown)

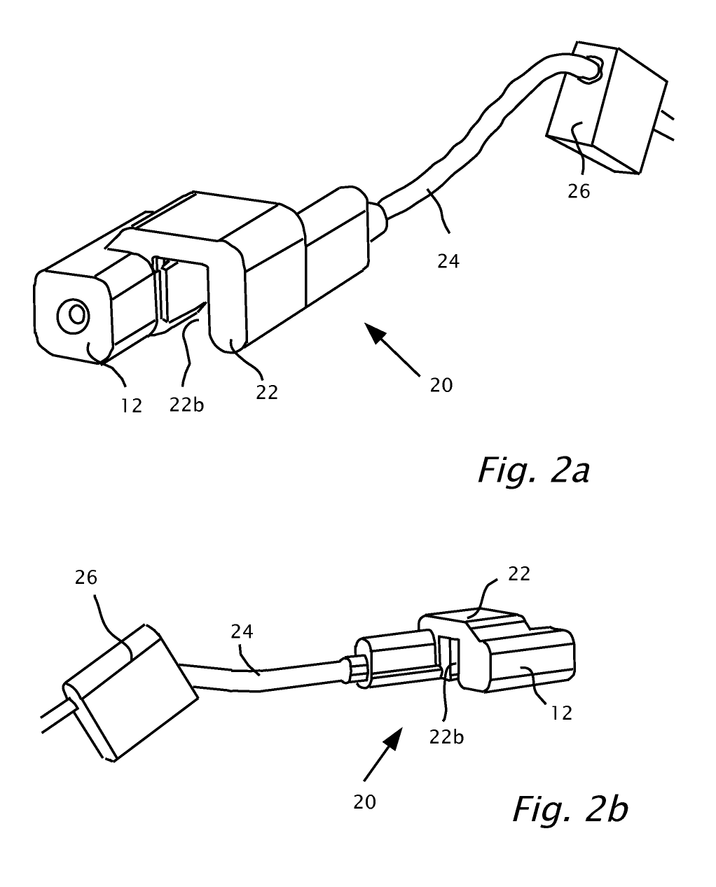

Reference is now made to FIG. 2a which shows a view of an apparatus 20, according a feature of the present invention. Camera 12 may be located in a housing which is attached to a mount 22. Mount 22 connects electrically to an audio unit 26 via a cable 24. A slot 22b is located between camera 12 and mount 22. Both camera 12 and audio unit 26 may be operatively connected to processor 16 and optionally storage 18. Processor 16 and storage 18 may be a custom unit or alternatively may be a mobile computer system, e.g. smart phone. Audio unit 26 (not shown) may be an audio speaker which may be in close proximity to and/or attached the ear of the user or located and attached at the bend in arm 32. Alternatively, audio unit 26 may be a bone conducting headphone set which may conduct through to one ear or to both ears of the person. Unit 26 may also be a earphone connected to processor 16 by a wireless connection, e.g. BlueTooth®.

Reference is now made to FIG. 2b which shows an alternative view of apparatus 20, showing camera 12, mount 22, slot 22b, cable 24 and audio unit 26, according to a feature of the present invention.

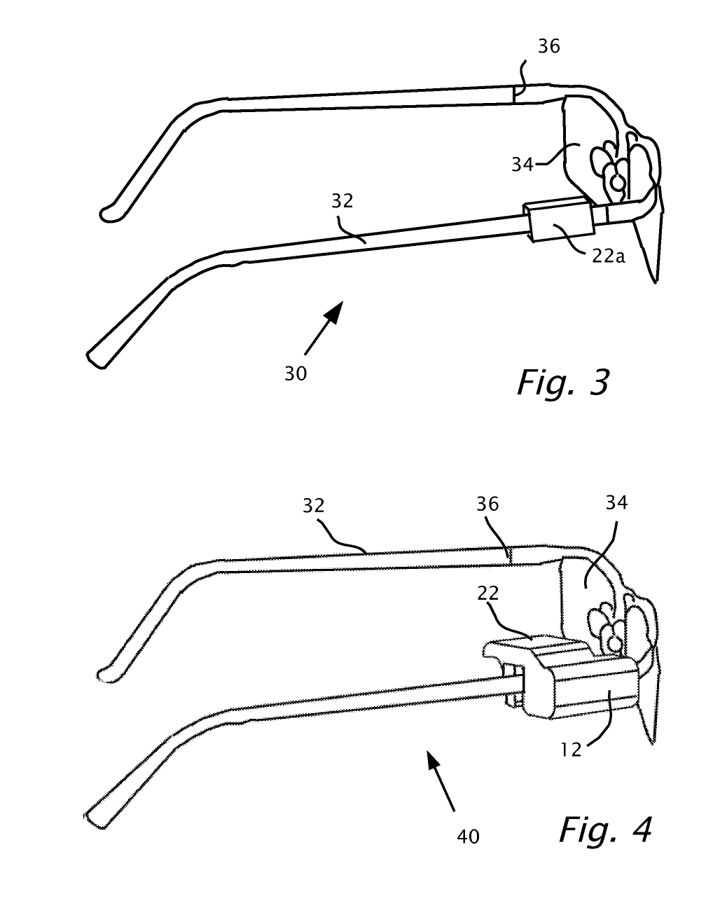

Reference is now made to FIG. 3 which shows eyeglasses 30 retrofit according to a feature of the present invention. Eyeglasses 30 has two arms 32 connected to the frame front of eyeglasses 30 with hinges 36. The frame front hold the lenses 34 of eyeglasses 30. A docking component 22a is attached to an arm 32 near to the frame front but just before hinge 36.

Reference is now made to FIG. 4 which shows a device 40 of eyeglasses 30 retrofit with at least a portion of apparatus 20, according to a feature of the present invention. Camera 12 may be docked on docking component 22a so that slot 22b between mount 22 and camera 12 slides onto docking component 22a. A magnetic connection between the slot and docking component 22a may allow camera 12 and mount 22 to be attachable, detachable and re-attachable to eyeglasses 30 via docking component 22a. Alternatively, a spring loaded strip located in the slot or on either side of docking component 22a (located behind hinge 36) may be utilized to allow camera 12 to be attachable, detachable and re-attachable to eyeglasses 30. Any other means known in the art of mechanical design may alternatively be utilized to allow camera 12 to be attachable, detachable and re-attachable to eyeglasses 30. Camera 12 is therefore, located to capture images frames 14 with a view which may be substantially the same view (provided through lenses 34 if applicable) of the person wearing eyeglasses 30. Camera 12 is therefore, located to minimize parallax error between the view of the person and view of camera 12.

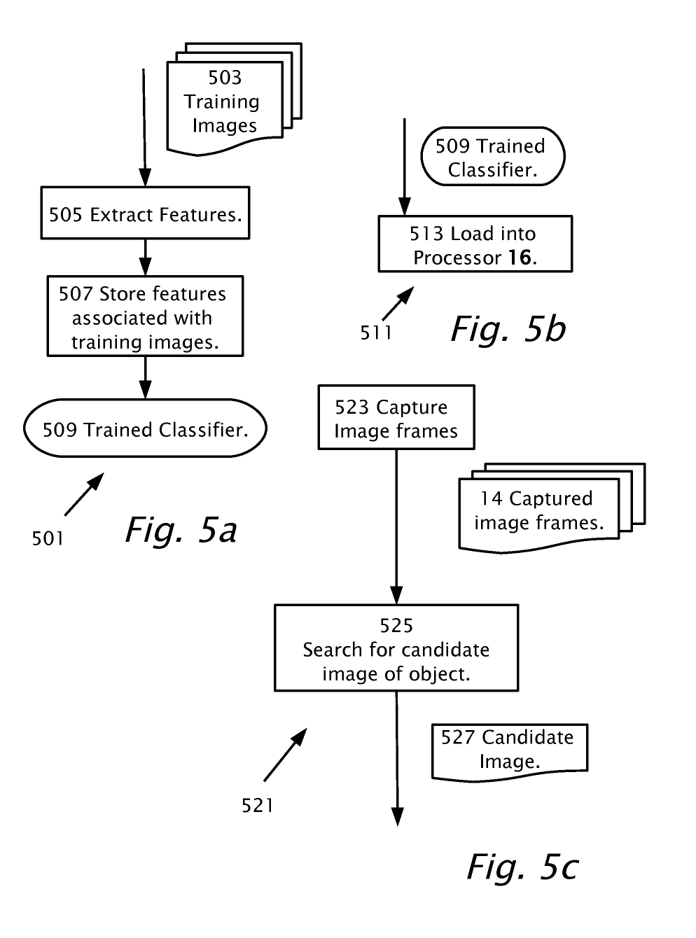

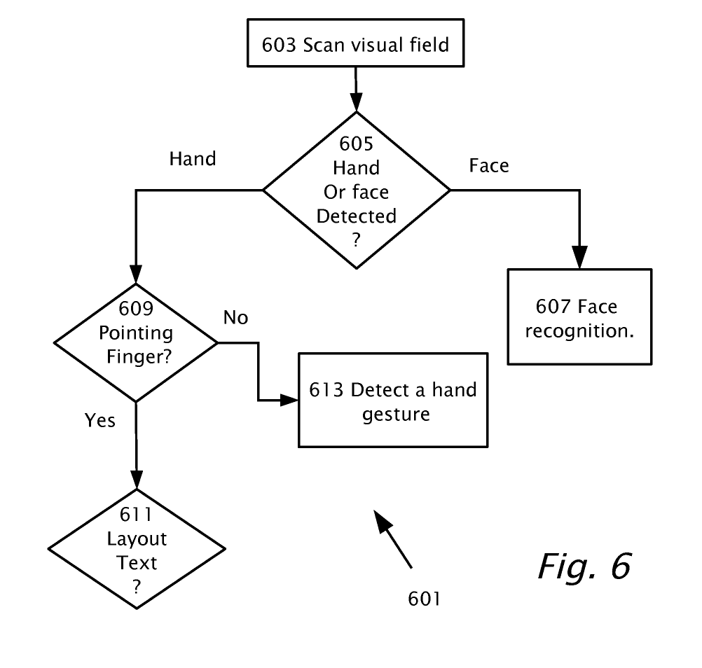

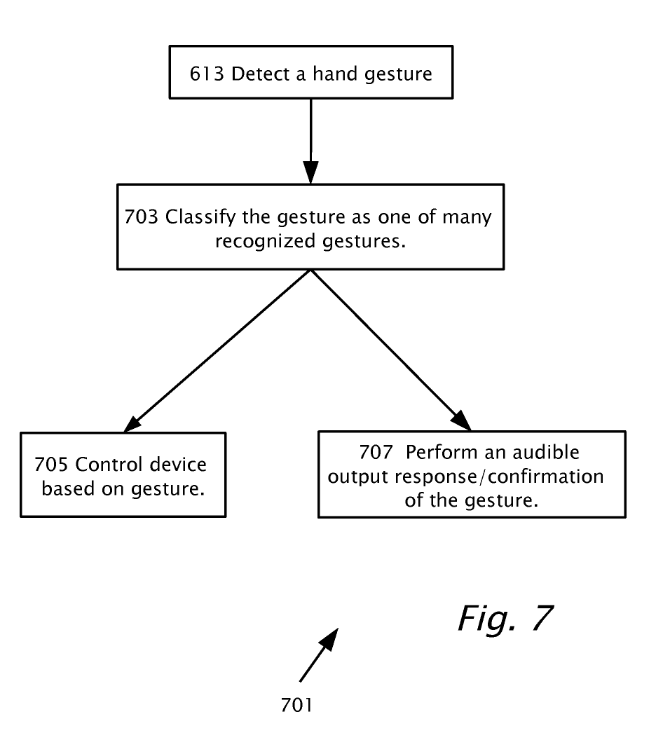

Reference is now made to FIG. 5a which shows a method 501 for training a multi-class classifier 509, according to a feature of the present invention. Training of classifier 509 is performed prior to using classifier 509 to classify for example gestures, bank notes, vehicles, particularly buses and/or traffic signals or traffic signs. Training images 503, for example of bank notes for a particular country, are provided and image features of the bank notes are extracted in step 505. Features extracted (step 505) from training images 503 may include optical gradients, intensity, color, texture and contrast for example. Features of the bank notes for a particular country may be stored (step 507) to produce a trained classifier 509. A similar exercise may be performed for steps 503 and 505 with respect to hand gestures. Features of hand gestures may be stored (step 507) to produce a. trained classifier 509. An example of a multi-class classifier 509 which may be produced includes the extracted features of both bank notes as one class of objects and hand gestures as another class of objects.

Optical flow or differences between image frames 14 may be further used classification for example to detect and recognition gesture motion or to detect and recognize the color change of a traffic signal

Reference is now made to FIG. 5b, which shows a method 511, according to a feature of the present invention, the trained classifier 509, is loaded into processor 16 in step 513.

Reference is now made to FIG. 5c, which shows a method 521, according to a feature of the present invention. With the trained classifier 509 loaded into processor 16 (step 513), image frames 14 are captured in step 523 of the various possible visual fields of the person wearing device 40. The captured image frames 14 are then used to search (step 525) for a candidate image 527 for an object found in the image frames 14. Further processing of candidate images 527 are shown in the descriptions that follow below.

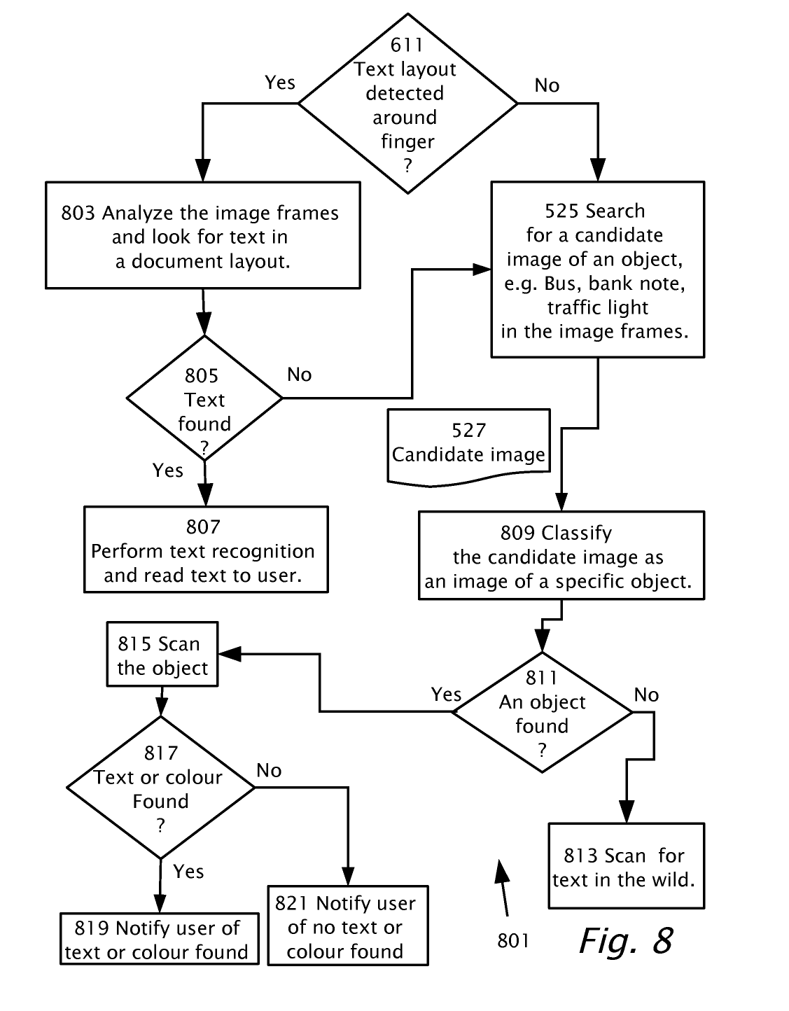

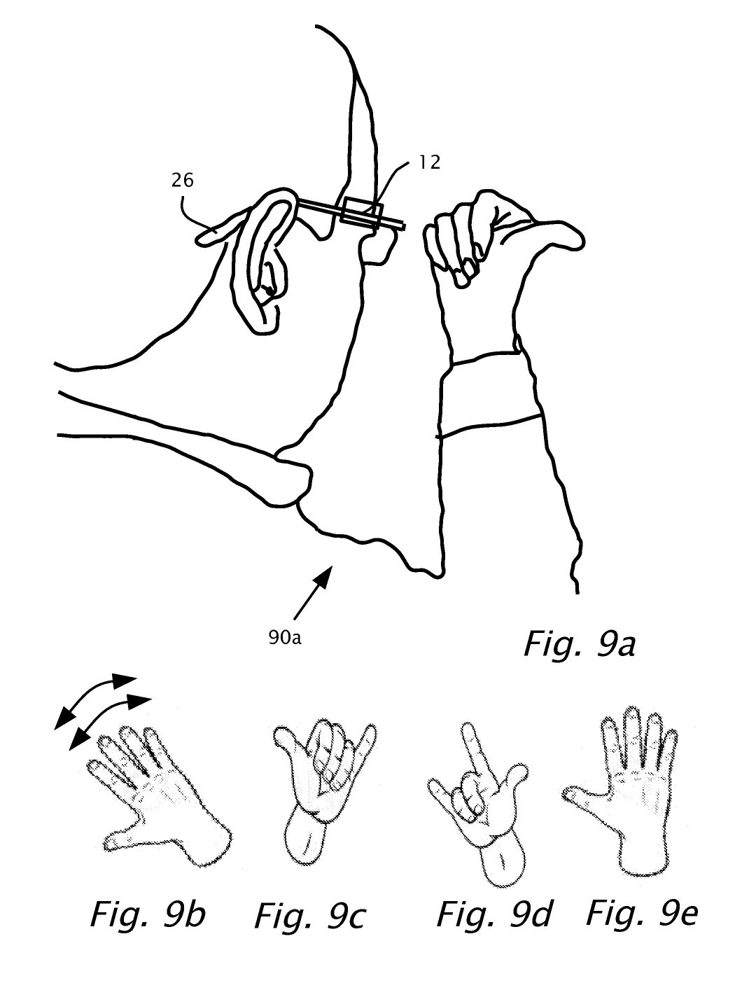

Reference is now made to FIG. 9a which shows a person wearing device 40 and visual field 90a of camera 12. The person is presenting a hand gesture in the field of view of camera 12. The gesture shown for example being the right hand palm side of the person with fingers closed and the thumb pointing out to the right. FIGS. 9b-9e show other example hand gestures which may be in visual field 90a of the person and camera 12. FIG. 9b shows the back or dorsal part of an open right hand which is being waved from side to side. FIG. 9c shows a palm side a left hand with thumb and little finger extended. FIG. 9d shows a palm side of a right hand with thumb, little finger and index finger extended. FIG. 9e shows the back or dorsal part of an open right hand which is stationary.

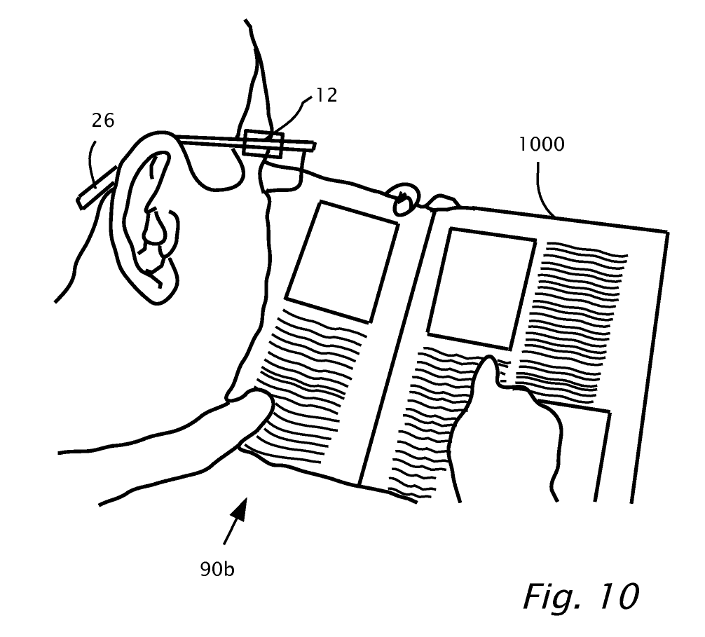

Reference is now made to FIG. 10 which shows a visual field 90b of a person wearing device 40. Visual field 90c of the person includes a document 1000 and the pointing of the index finger of the right hand to text in document 1000. Document 1000 in this case is a book but also may be a timetable, notice on a wall or a text on some signage in close proximity to the person such as text on the label of a can for example.

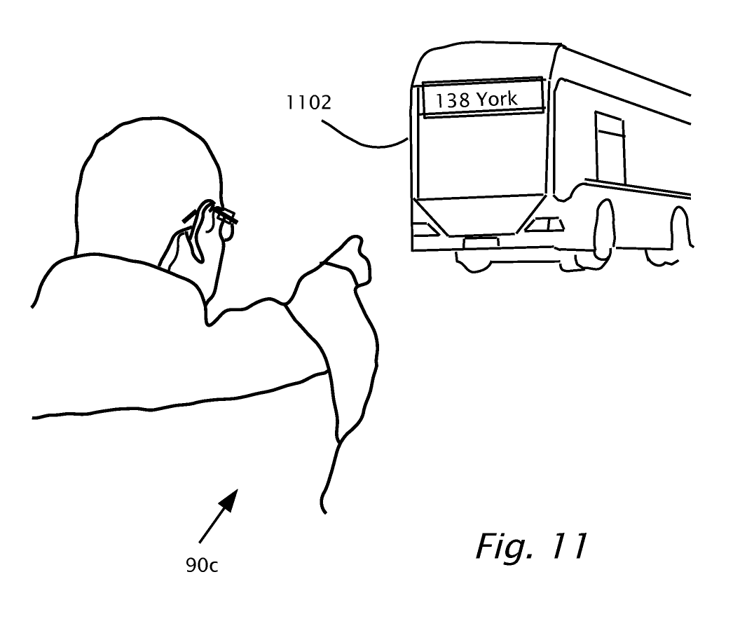

Reference is now made to FIG. 11 which shows a visual field 90c of a person wearing device 40. Here visual field 90c includes a bus 1102 and the pointing of the index finger of the right in the general direction of bus 1102. Bus 1102 also includes a text such as the bus number and destination. The text may also include details of the route of bus 1102.

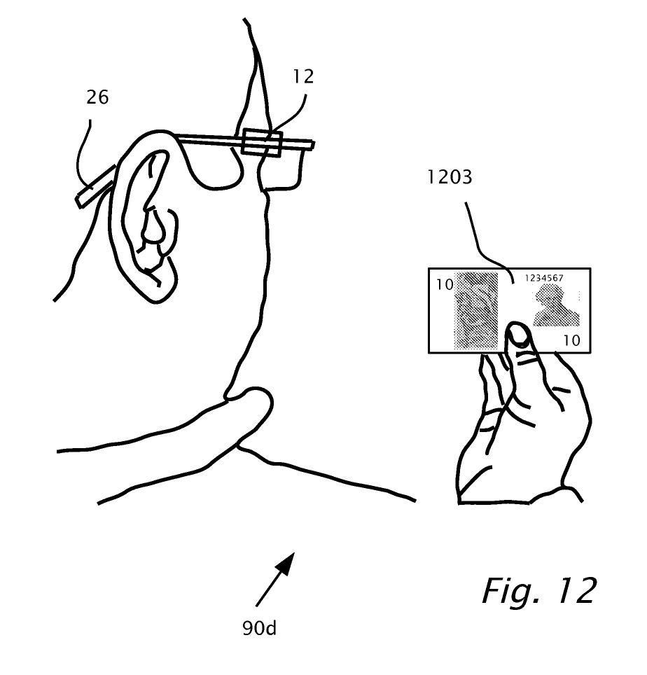

Reference is now made to FIG. 12 which shows a visual field 90d of a person wearing device 40. Visual field 90d includes the person holding a banknote 1203 or visual field 90d may have banknote 1203 on a counter top or in the hands of another person such as shop assistant for example.

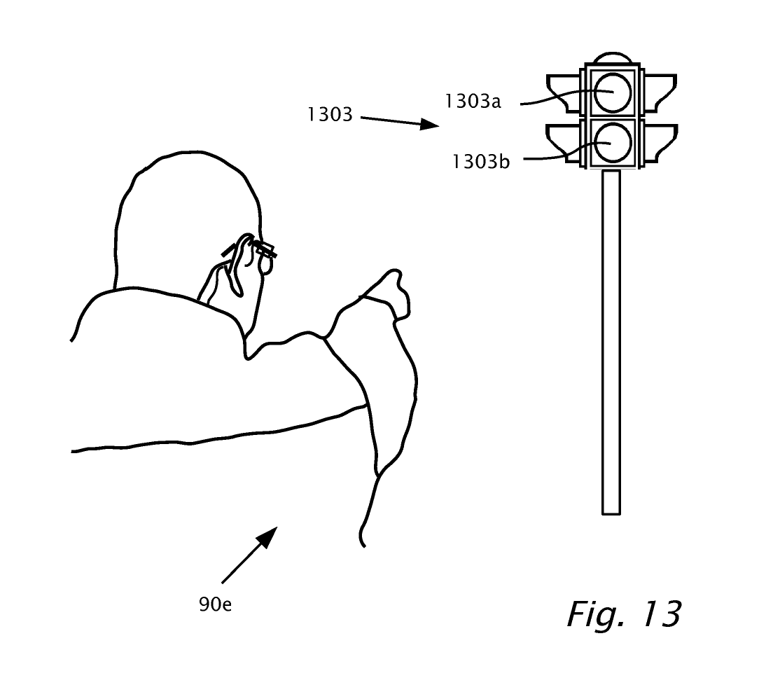

Reference is now made to FIG. 13 which shows a visual field 90e of a person wearing device 40. Here visual field 90c includes a traffic signal 1303 and the pointing of the index finger of the right in the general direction of traffic signal 1303. Here traffic signal has two sign lights 1303a (red) and 1303b (green) which may be indicative of a pedestrian crossing sign or alternatively traffic signal 1303 may have three sign lights (red, amber, green) indicative of a traffic sign used by vehicles as well as pedestrians.

Reference is now made to FIG. 6 which shows a method 601, according to a feature of the present invention. In step 603 the visual field 90 of the person and camera 12 may be scanned while device 40 is worn by the person. In decision block 605 a decision is made to determine if an object detected in visual field 90 is either a hand of the person or a face of another person. If the object detected is the face of another person, facial recognition of the other person may be performed in step 607. Facial recognition step 607 may make use of classifier 120 which has been previously trained to recognize the faces people who are known to the person. If the object detected in visual field 90 is a hand of the person, in decision box 609 it may be determined if the hand gesture is a pointing finger gesture or not. The pointing finger may be for instance a pointing index finger of the right hand or left hand of the person. If the hand does not include a pointing finger, then hand gestures may be detected starting in step 613 the flow of which continues in FIG. 7. If the finger is pointing to an attribute such as a text layout in decision box 611, the flow continues in FIG. 8.

Reference is now made to FIG. 7 which shows a method 701, according to a feature of the present invention. Method 701 is a continuation of step 613 shown in FIG. 6. In step 613 a hand gesture of a user is detected and recognized to not include a pointing finger. In step 703 the hand gesture may be classified as one of many recognizable gestures of trained classifier 509. Recognizing the hand gesture as one of many hand gestures may simultaneously provide control (step 705) of device 40 based on the hand gesture as well as providing an audible output via audio unit 26 in response to and/or in confirmation of the hand gesture (step 707). In step 705, control of device 40 may include gestures to recognize colours, to stop a process of recognizing just buses for example, increase the volume of unit 26, to stop and/or start reading recognized text, to start recording video or to take a picture. In step 707, the audible output may be click sound, bleep, a one word confirmation or to notify the person that a specific mode has been entered, such as just looking for buses and bus numbers for example. Audible output response in step 707 may alternatively or in addition include information or data related to a recognized object.

Reference is now made to FIG. 8 which shows a method 801, according to a feature of the present invention. Method 801 shows the continuation of decision step 611 shown in FIG. 6. Decision step 611 is reached by virtue of finding a finger pointing in visual field 90 in step 609. In decision step 611 it is determined if a text layout is detected around a pointing finger and if so, the resolution of camera 12 may be increased to enable analysis (step 803) of image frames 14 so as to look for example for a block of text within the text layout of a document. If text is found in decision block 805, recognition of the text is performed in step 807 and the text may be read to the person via audio unit 26. The index finger may be used to point to which specific portion of text to be recognized and to be read in the document.

In both decision boxes 805 and 611, if no text is found, a search for a candidate image 527 in the field of view 90 for an object may be performed in step 525. The search in step 525 may be made with a lower resolution of camera 12 to enable searching of the object in image frames 14. The object may be a vehicle such as a bus, a bank note and/or traffic light shown in views 90c, 90d and 90e respectively for example. The candidate image 527 may then be classified in step 809, using classifier 509 as an image of a specific object. Additionally, the person may track the candidate image to provide a tracked candidate image in the image frames 14. The tracking may be based on sound perception, partial vision or situational awareness by orienting the head-worn camera 12 in the direction of the object. The tracked candidate image may be then selected for classification and recognition.

In decision block 811, if an object is found, it may be possible to inform the person what the object is (bus 1102, bank note 1203 or traffic signal 1303 for example) and to scan the object (step 815) for attributes of the object such as text, colour or texture. If text and/or colour is found, in decision 817 on or for the object, the user may be audibly notified (step 819) via audio unit 26 and the recognized text may be read to the person. In the case of bus 1102 the bus number may be read along with the destination or route based on recognized text and/or colour of the bus. In the case of bank note 1203 the denomination of the bank note (5 British pounds or 5 American dollars) may be read to the person based on recognized text and/or colour or texture of the bank note. In the case of traffic signal 1303 based on the colour of traffic signal 1303 or a combination colour and/or text of traffic signal 1303 to stop or to walk.

If no text is found on the object then the user may be audibly notified (step 821) via audio unit 26 that no text has been found on the object. In decision step 811, if no object is found, then a scan for any text in the image frames 14 may be made in step 813. Decision step 817 may be run again after step 813 to notify of text (step 819) and unit 26 to read the text or notify (step 821) of no text found.

The indefinite articles “a”, “an” is used herein, such as “a candidate image”, “an audible output” have the meaning of “one or more” that is “one or more candidate images” or “one or more audible outputs”.

Although selected features of the present invention have been shown and described, it is to be understood the present invention is not limited to the described features. Instead, it is to be appreciated that changes may be made to these features without departing from the principles and spirit of the invention, the scope of which is defined by the claims and the equivalents thereof.

1. A method for visually assisting a person using a device wearable by the person, the device including a camera and a processor wherein the processor is adapted to capture a plurality of image frames from the camera, the method comprising:
searching for a candidate image in the image frames;
classifying thereby recognizing said candidate image as an image of an object; and
notifying the person of an attribute related to the object.

2. The method of claim 1, wherein said candidate image includes a specific hand gesture, wherein said classifying includes recognizing the specific hand gesture.

3. The method of claim 2, further comprising:
audibly confirming to the person that the specific hand gesture is recognized.

4. The method of claim 2, wherein said candidate image includes the object in the environment of the person other than a hand gesture, the method further comprising:
controlling the device responsive to the object in the environment.

5. The method of claim 1, further comprising:
tracking by the person by maintaining said candidate image in the image frames to provide a tracked candidate image; and
selecting said tracked candidate image for said classifying.

6. The method of claim 1, wherein the object is selected from the group of classes consisting of: buses, traffic signals and bank notes.

7. The method of claim 1, wherein the object is selected from the group consisting of buses.

8. The method of claim 1, wherein the object is selected from the group consisting of: buses and a traffic signals.

9. The method of claim 1, wherein the object is selected from the group consisting of: buses and bank notes.

10. The method of claim 1, wherein the object is selected from the group consisting of: traffic signals and bank notes.

11. The method of claim 1, wherein the object is a bus and the attribute is selected from the group consisting of: the number of the bus line, the destination of the bus, and the route of the bus.

12. The method of claim 1, wherein the object is a traffic signal and the attribute includes the state of the traffic signal.

13. The method of claim 1, wherein the object is a bank note and the attribute includes the denomination of said bank note.

14. A device wearable by the person for visually assisting a person using the device, the device including a camera and a processor wherein the processor is adapted to capture a plurality of image frames from the camera, the operable to:
search for a candidate image in the image frames;
classify thereby recognize said candidate image as an image of an object; and
notify the person of an attribute related to the object.

15. The device of claim 14, wherein said candidate image includes a specific hand gesture, wherein the device is operable to classify the specific hand gesture.

16. The device of claim 15, further operable to:
audibly confirm to the person that the specific hand gesture is recognized.

17. The device of claim 14, wherein the object is selected from the group of classes consisting of: buses, traffic signals and bank notes.

18. The device of claim 14, wherein the object is selected from the group consisting of buses.

19. The device of claim 14, wherein the object is selected from the group consisting of: buses and traffic signals.

20. The device of claim 14, wherein the object is selected from the group consisting of: buses and bank notes.
